(19) United States
(12) Patent Application Publication
(10) Pub. No.: US 2002/0107921 A1
(43) Pub. Date: Aug. 8, 2002

(54) Work-flow cooperation processing apparatus, work-flow cooperation processing system, work-flow-system cooperation method, program therefor, and recording medium therefor

(76) Inventor: Kazuya Kishimoto, Matsumoto-shi (JP)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/051,221

(22) Filed: Jan. 18, 2002

(30) Foreign Application Priority Data
Feb. 2, 2001 (JP) 2001-026709

(51) Int. Cl. G06F 15/16

(52) U.S. Cl. 709/205

(57) ABSTRACT

To achieve easy cooperation among a plurality of work-flow systems, a workflow cooperation processing apparatus is connected to a first work-flow system and reads, via a network, electronic mail which is sent from a second work-flow system and stored in an electronic-mail storage apparatus. The electronic mail includes a command related to a work flow in the first work-flow system. The work-flow cooperation processing apparatus transmits the command included in the read electronic mail to the first work-flow system to execute the command.

### BACKGROUND OF THE INVENTION

1. Field of the Invention

The present invention relates to work-flow cooperation processing apparatuses, work-flow cooperation processing systems, work-flow-system cooperation methods, programs therefor, and recording media therefor, and more particularly, to a work-flow cooperation processing apparatus, a work-flow cooperation processing system, a work-flow-system cooperation method, a program therefor, and a recording medium therefor which can achieve cooperation among work-flow systems by using electronic mail.

2. Description of the Related Art

As computers in companies have recently performed work, various types of work have been achieved by so-called work-flow systems employing computer systems. Usually, a plurality of terminal apparatuses in a computer system constituting a work-flow system are connected via a network. When predetermined work is finished at each terminal apparatus, that is, when work is finished at each node in a so-called work flow, the work-flow system automatically reports the termination of the work or designates the next work to be processed to a terminal apparatus of a person who should handle work thereafter, in response to a termination instruction. In this way, a work-flow system controls the flow of continuous work, and automatically designates various types of work processing from one person to another person or from one terminal apparatus to another terminal apparatus to achieve quick and correct work processing.

Such work-flow systems are generally configured by using configuration software for configuring work-flow systems in a variety of situations. Alternatively, work-flow systems are configured in particular situations by using a work-flow processing function included in special software for work, such as software for development and design.

However, when a plurality of work-flow systems are separately configured by using different configuration software or the like, it is difficult to achieve cooperation of work-flow processing among the work-flow systems.

Therefore, to achieve cooperation, in the middle of work processing in a work-flow system, with predetermined work processing in another work-flow system, a person needs to activate a work flow related to the predetermined work processing in the another work-flow system after that person determines whether the predetermined work processing is required, or according to a separately specified manual. For example, after design for a certain component is finished for mass production in a work-flow system for development and design, a purchasing department would need to order the component from a supplier. If the work-flow system in a development and design department differs from that in the purchasing department, a person in charge in the development and design department would need to make contact with the purchasing department to activate a predetermined work flow of the purchasing department.

When the number of such unusual processing events is small and personnel can sufficiently handle the processing load, no problem occurs. But if the number increases, the processing and management therefor become complicated and an error may easily occur.

Configuring new integrated work-flow systems for only a few cooperating processes, instead of existing work-flow systems, is unrealistic in terms of time and cost in many cases.

### OBJECTS OF THE INVENTION

Accordingly, an object of the present invention is to provide a work-flow cooperation system that easily achieves cooperation among independent work-flow systems and which allows one work-flow system to activate a work flow in another work-flow system.

### SUMMARY OF THE INVENTION

A work-flow cooperation processing apparatus according to the present invention achieves cooperation among at least two work-flow systems, a first one of the work-flow systems including at least a first computer apparatus serving as a work-flow server and an electronic mail sender, a second one of the work-flow systems including at least a second computer apparatus serving as a work-flow server. A network connects at least the first computer apparatus and the electronic mail storage. The work-flow cooperation processing apparatus comprises a method-server apparatus that connects to the network and to the second computer apparatus, that reads electronic mail from the electronic mail storage, the electronic mail being sent from the first computer apparatus and including a command related to work flow in the second work-flow system, and that transmits a command forming part of the electronic mail to the second computer apparatus for execution of the command by the second computer apparatus.

With such a structure, cooperation can easily be achieved among a plurality of work-flow systems.

It is preferred in the work-flow cooperation processing apparatus of the present invention that the first work-flow system send the electronic mail to the electronic-mail storage and store it therein according to whether electronic-mail processing is designated at each node of a work flow in the first work-flow system.

With such a structure, a command sent to a work flow of another work-flow system can be controlled according to processing in each node.

It is preferred that the work-flow cooperation processing apparatus according to the present invention further determine, according to the content of the read electronic mail, whether the read electronic mail is related to a work flow in the second work-flow system, and when the read electronic mail is related to a work flow in the second work-flow system, the command included in the electronic mail is sent to the second work-flow system.

According to such a structure, a work-flow cooperation processing apparatus can cause execution of commands only in a particular work-flow system related to a particular apparatus in a plurality of work-flow systems.

It is preferred that the command of the present invention be an activation command for activating a work flow in a work-flow system.

In this case, a desired work flow in another work-flow system can be activated.

It is preferred that the electronic mail of the present invention be text data, and the text data include a parameter specifying a work flow in a work-flow system.

In this case, a desired work flow to be executed can be specified.

A work-flow cooperation processing system according to the present invention includes first and second work-flow systems; electronic-mail storage apparatus that stores electronic mail sent from the first work-flow system; a method-server apparatus that connects to the second work-flow system, that reads electronic mail from the electronic mail storage apparatus, the electronic mail being sent from the first work-flow system and including a command related to work flow in the second work-flow system, and that transmits a command forming part of the electronic mail to the second work-flow system for execution of the command.

With such a structure, cooperation can easily be obtained among a plurality of work-flow systems.

A work-flow-system cooperation method for a plurality of work-flow systems, according to the present invention comprises the steps of: storing electronic mail sent from a first one of the plurality of work-flow systems in an electronic-mail storage; reading out the electronic mail from the electronic-mail storage; sending a command related to a work flow in a second one of the plurality of work-flow systems to the second one of the work-flow systems, the command included in the read-out electronic mail; and executing the sent command for the work flow in the second one of the work-flow systems.

With such a method, cooperation can easily be obtained among a plurality of work-flow systems.

A program according to the present invention is a program that is executable by a computer for performing the work-flow-system cooperation method of the present invention.

With such a program, the program that executes a work-flow-system cooperation method of the present invention can be distributed or provided through a communication network or a recording medium, and when the program is installed in a computer, the work-flow-system cooperation method according to the present invention can easily be implemented.

A computer-readable recording medium according to the present invention stores the program for executing the steps of the work-flow-system cooperation method of the present invention.

With such a medium, the program that executes the work-flow-system cooperation method according to the present invention is stored in a medium, and when the medium is installed and the program is loaded in a computer, the workflow-system cooperation method according to the present invention can easily be implemented.

### BRIEF DESCRIPTION OF THE DRAWINGS

FIG. 1 is a system block view showing the whole structure of a work-flow-system cooperation processing system formed of two work-flow systems according to a first embodiment of the present invention.

FIG. 2 is a view showing cooperation between first and second work-flow systems.

FIG. 3 is a flowchart of electronic-mail processing in each node in each workflow system.

FIG. 4 is a flowchart of processing in a method-server of the present invention.

FIG. 5 is a view showing example text data in the body of electronic mail.

FIG. 6 is a system block view showing the whole structure of a work-flow cooperation system according to a second embodiment of the present invention.

### DESCRIPTION OF THE PREFERRED EMBODIMENTS

Embodiments of the present invention will be described below by referring to the drawings.

A first embodiment will be described first.

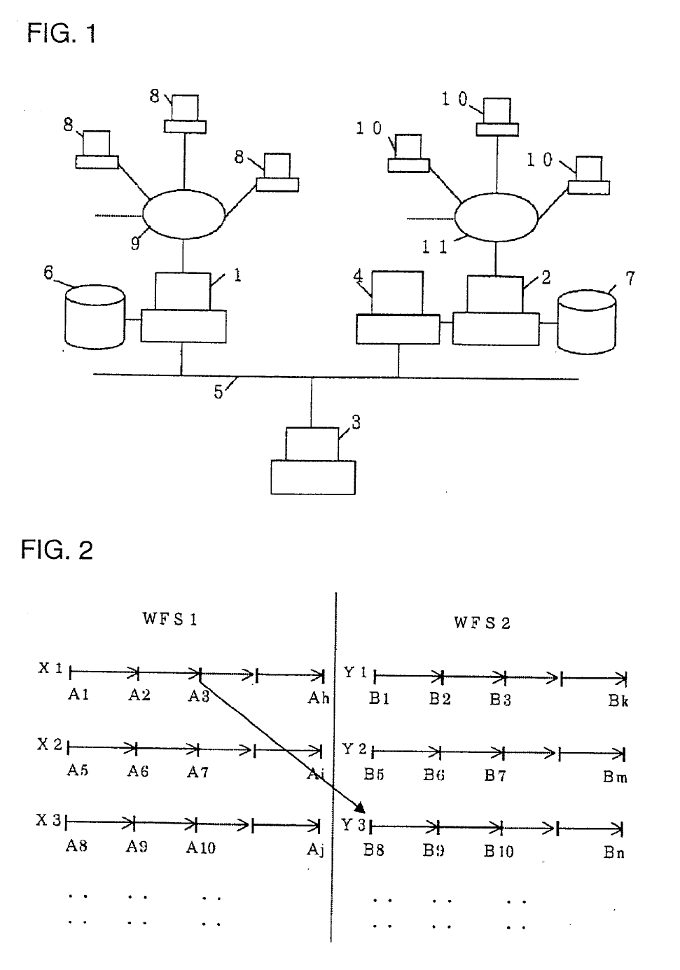

FIG. 1 to FIG. 5 show the first embodiment. FIG. 1 is a system structural view showing the entire structure of a work-flow-system cooperation processing system including two work-flow systems.

A computer apparatus 1 serves as a work-flow server in a first work-flow system. A computer apparatus 2 serves as a work-flow server in a second work-flow system. A method server apparatus 4 serves as a cooperation processing apparatus connected to the computer apparatus 2. The computer apparatus 1 and the method server apparatus 4 are connected to a communication network 5. A memory apparatus 6 is connected to the computer apparatus 1. A memory apparatus 7 is connected to the computer apparatus 2. There are also shown terminal apparatuses 8 and 10, such as personal computers. As will be appreciated, each of the computer apparatus and method server apparatus may comprise personal computers, network computers, servers, etc.

A plurality of terminal apparatuses 8 can transmit and receive data to and from the computer apparatus 1 and to and from each other through a communication network 9. A plurality of terminal apparatuses 10 can transmit and receive data to and from the computer apparatus 2 and to and from each other through a communication network 11.

The memory apparatus 6 stores a program for the first work-flow system, and the memory apparatus 7 stores a program for the second work-flow system. The computer apparatus 1 or 2 that operates the corresponding work-flow system reads the program for the work-flow system stored in the memory apparatus 6 or 7 and executes it. The computer apparatus 1 or 2 gives necessary work-processing instructions to corresponding terminal apparatuses and operators according to the program in an order defined in the work-flow system.

A mail-server apparatus 3 is a computer apparatus that stores electronic mail sent from the computer apparatus 1 through the communication network 5 and enables the method-server apparatus 4 to receive the electronic mail, and can be a usual so-called mail server. The method-server apparatus 4 reads out the data comprising the electronic mail stored in the mail-server apparatus 3 that includes electronic mail storage and serves as electronic-mail storage means, and sends an execution command to the computer apparatus 2, which manages the work-flow system, as described later, according to the contents of the electronic mail.

The two work-flow systems are operated by separate terminal apparatuses on the separate communication networks 9 and 11, but may be operated by terminal apparatuses on one communication network. In this case, a single physical terminal apparatus may perform processing for the two work-flow system by switching the processing program.

FIG. 2 is a view showing how the first and second work-flow systems cooperate. The first work-flow system (WFS1) is formed of a plurality of work flows X1, X2, X3, . . . The second work-flow system (WFS2) is formed of a plurality of work flows Y1, Y2, Y3 . . . Each work flow is formed of a plurality of processing units (A1, A2, A3, . . . , B1, B2, B3, . . . ) called nodes. In a work-flow system, processing of work processed in each node in each work flow and the order of nodes are defined in advance. In addition, a terminal apparatus that performs work processing in each node in each work flow and a person in charge of the work processing are also defined. Therefore, the work-flow system gives instructions in the defined order to the defined person in charge of the work processing at the defined terminal apparatus in order to perform the work processing at each node in each work flow.

In FIG. 2, the processing of a work flow indicated by X1 starts at node A1 and ends at node Ah. When the processing of node A1 is finished, the processing of node A2 is executed. Then, when the processing of node A2 is finished, the processing of node A3 is executed. In this way, the work-flow system controls a work flow. When the processing of the last node Ah is finished, the work flow X1 is finished.

The other work flows (X2, X3, . . . Y1, Y2, Y3, . . . ) are defined in the same way and execution thereof is controlled.

It is assumed here, for example, that the work-flow system WFS1 is a work-flow system of a design department in a company, and the work-flow system WFS2 is that of a purchasing department of the company. In the work-flow system WFS1, each work flow is defined for a product or for a design section. In the work-flow system WFS2, each work flow is defined for a component, or for a supplier. A plurality of work flows defined in this way are executed and managed to automatically perform product-design work and purchasing work smoothly as an integrated process.

These two work-flow systems WFS1 and WFS2 are configured separately and independently, but there are some situations in which mutual cooperation is required. For example, there is a point at which, when a certain component has been designed, that is, when design approval is given, an order is to be made for that certain component soon thereafter.

In FIG. 2, an arrow from node A3 to node B8 indicates that when processing at node A3 in the work flow X1 is finished, a work flow Y3 is to be started. Work at node A2 is design work for a certain component performed by a person in charge of design. When the design work has been finished, his or her superior checks the design work and approves it at node A3. When checking has been finished and approval is finally obtained at node A3, work at the next node (not shown) is executed. Execution of the work flow X1 is thus controlled. The arrow from node A3 to the work flow Y3 in FIG. 2 indicates that when the approval is obtained at node A3, the work flow Y3 in the work-flow system WFS2 is started in parallel, so that the certain component can be purchased in the middle of the work flow X1. In the work flow Y3, the inventory of the certain component is checked, and a request for an estimate thereof is sent to a predetermined supplier according to the result of checking step.

When a work-flow system sequentially performs processing of defined nodes, it always checks whether the processing of each node has been finished. When the processing of a node is approval processing for a design drawing of a certain component, for example, the work-flow system WFS1 checks whether an approval command has been issued. An approval command indicates a termination instruction in the node processing. For example, an operator clicks an approval button on a screen of a terminal apparatus to instruct termination. When the approval button corresponding to a termination command is pressed or selected, the work-flow system WFS1 knows that the node processing has been finished, and proceeds to execution processing of the next defined node. A work-flow system controls execution of nodes while monitoring the termination of processing of nodes in this way.

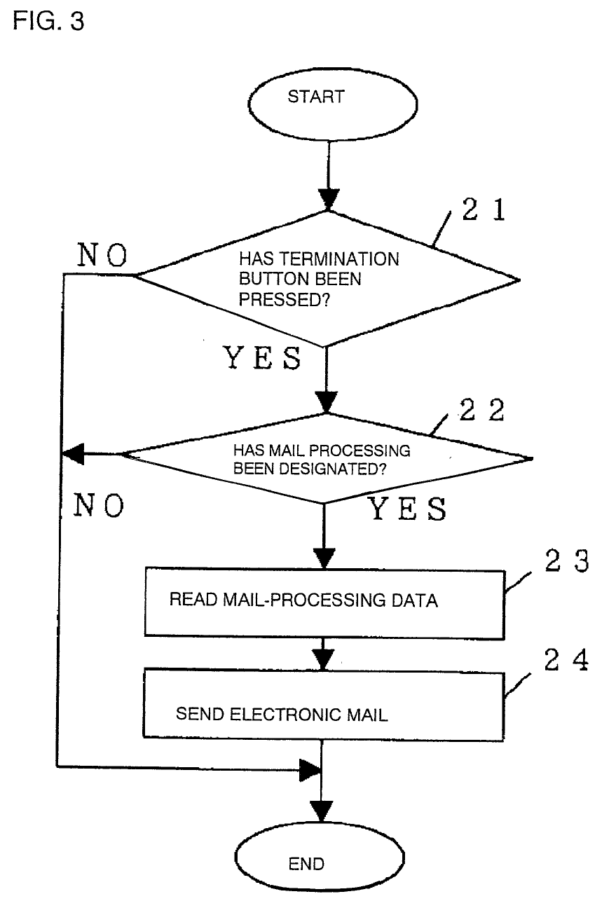

FIG. 3 is a flowchart of electronic-mail processing performed in each node in the work-flow system WFS1. In FIG. 3, the computer apparatus 1 serving as a work-flow server executes the processing.

In FIG. 3, it is first determined in step (hereinafter abbreviated to S) 21 whether a termination button indicating the termination of processing of a node has been pressed or selected. If the termination button has not yet been pressed, NO results in S21, and nothing is performed. If the termination button has been pressed, YES results in S21, and it is determined in S22 whether mail processing, described later, has been designated when the node processing is terminated. When the mail processing has not been designated, NO results in S22, nothing is performed, and the work-flow system performs processing of the next defined node. When YES results in S22, mail-processing data stored in a predetermined area of the memory apparatus 6 is read in S23.

The mail-processing data includes a destination address for the electronic mail and text data serving as a body of the mail. The electronic mail, including the text data, is sent to the destination address in S24. In this case, the destination address is an address in the mail-server apparatus 3.

Mail processing is designated or not designated for each node. Whether mail-processing has been designated is checked when the computer apparatus of the work-flow system reads flag data stored as flag information corresponding to each node in a predetermined area in the memory apparatus. For example, flag information corresponding to each node is stored in a table form. When flag data is “1,” mail processing has been designated for the corresponding node. When flag data is “0,” mail processing has not been designated for the corresponding node.

When flag data is “1,” mail-processing data corresponding to the node is read when processing of the node is finished. The mail-processing data is also stored in a predetermined area in the memory apparatus correspondingly to each node.

The electronic mail sent to the mail-server apparatus 3 includes a command used to activate a predetermined work flow in the work-flow system WFS2. More specifically, the command is written in the body of the mail. The method-server apparatus 4 of the work-flow system WFS2 takes out or reads out the mail from the mail server and determines whether the command relates to a work flow associated with its work flow system, that is, one of work flows Y1, Y2, Y3, etc. When the command relates to a work flow of the WFS2, in order to execute the contents of the command, the WFS2 sends an activation command to the computer apparatus 2 serving as a work-flow server. In response to the sent activation command, the computer apparatus 2 activates the work flow Y3 in the work-flow system WFS2 in the case shown in FIG. 2.

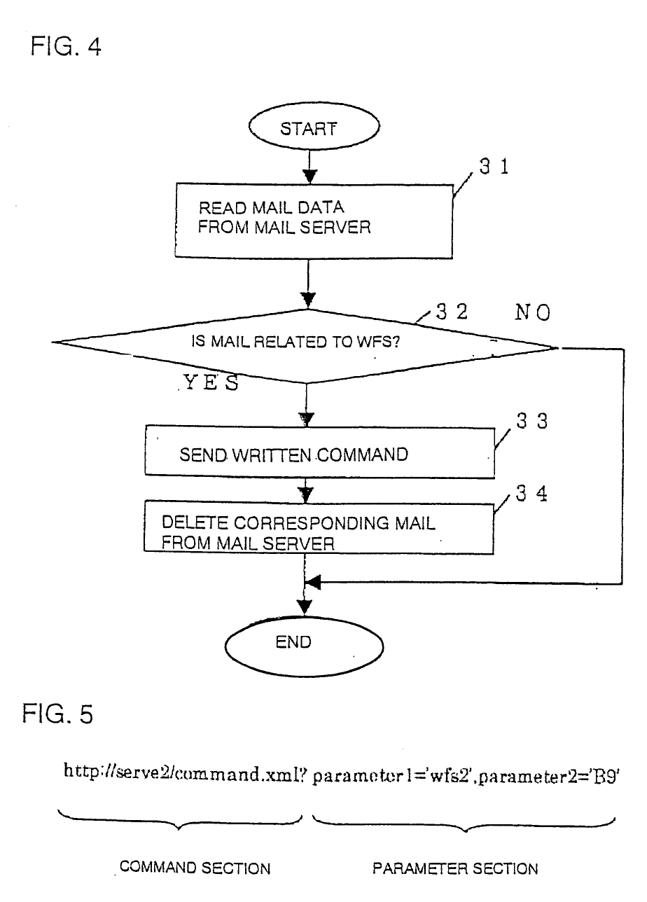

FIG. 4 is a flowchart of the processing performed by the method-server apparatus 4.

The method-server apparatus 4 takes out or reads out mail data from the mail-server apparatus 3 in S31. The method-server apparatus 4 uses a usual mail-receiving program such as POP3 in an electronic-mail processing system. The method-server apparatus 4 takes out mail from the mail-server apparatus 3 at predetermined time intervals, and checks in S32 whether the mail relates to the work-flow system associated with the method-server apparatus 4. More specifically, the method-server apparatus 4 of the work-flow system WFS2 checks whether the mail is related to one of the work flows Y1, Y2, Y3, . . . in the work-flow system WFS2. When NO results in S32, nothing is performed, and the processing is terminated.

When YES results in S32, that is, when it is determined that the mail is for the related work-flow system, a command written in the body of the mail in text is sent to the computer apparatus 2 serving as a work-flow server in S33. The contents written in text include a command and a parameter, as described later. The method-server apparatus 4 sends the contents of the electronic mail to the work-flow server, and then deletes the electronic mail from the mail-server apparatus 3 in S34. A usual electronic-mail receiving program is used to delete the mail.

In the above-described case, the electronic mail sent when the processing in node A3 of the work flow X1 in the work-flow system WFS1 is finished is stored in the mail-server apparatus 3. The electronic mail includes the command used to activate the work flow Y3 in the work-flow system WFS2. The method-server apparatus 4, connected to the computer apparatus 2, reads the electronic mail stored in the mail-server apparatus 3, and sends it to the computer apparatus 2.

FIG. 5 is a view showing example text data in the body of electronic mail.

This text data includes a command section and a parameter section. In the command section, the command itself and an apparatus for executing the command are written. The command section disposed at the left in FIG. 5 indicates that the apparatus for executing the command is “serve2” and the command is written in “xml.” The parameter section disposed at the right in FIG. 5 indicates data that designates a work flow that executes the command. In FIG. 5, a first parameter in the parameter section indicates the work-flow system 2 by “wfs2,” and a second parameter indicates node B9 by “B9.” The function of this text data is to activate node B9 in the work-flow system 2.

In other words, in the case shown in FIG. 5, the method-server apparatus 4 determines that the command is related to the computer apparatus 2 serving as a work-flow server because the apparatus that executes the command is set to “serve2” in the command section, and determines that the command is written in the format of “xml.” The method-server apparatus 4 sends an activation command for the work flow “Y3” in the work-flow system “wfs2,” which is written in the parameter section of the command, to the computer apparatus 2. The computer apparatus 2 activates the work flow Y3 in response to the activation command sent from the method-server apparatus 4.

The work-flow system 2 may be configured such that, when the method-sever apparatus 4 reads out the text of electronic mail and determines that the electronic mail is for the related work-flow system, the method-server apparatus 4 sends the text itself to the computer apparatus 2 serving as a work-flow server, and the computer apparatus 2 analyzes the contents of the text and executes the included command.

As described above, in response to the termination of processing at a node in one work-flow system, a work flow in the other work-flow system can be activated.

Therefore, even in two independent work-flow systems, cooperation can easily be obtained by using electronic mail.

When a method-sever apparatus is connected to the computer apparatus 1, the computer apparatus 2 sends electronic mail to the mail-server apparatus 3; and the method-server apparatus for system WFS1 periodically checks electronic mail. Thus, work flows in the work-flow systems WFS1 and WFS2 can be activated mutually between them.

The above-described command is just an example. Commands may be written in a different format. Commands are specified between work-flow systems, or between a work-flow system and a method server, and they can be written in various formats depending on the specification. For example, they may be written in an XML (extensible mark-up language) format, or in a URL (uniform resource locator) format, which is frequently used in web systems.

A second embodiment will be described next.

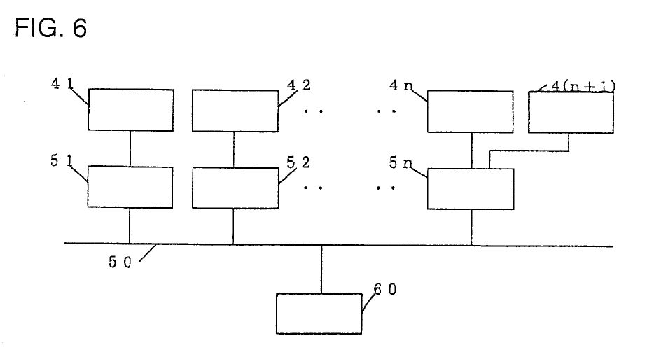

FIG. 6 is a structural view showing the entire structure of a work-flow cooperation system according to the second embodiment. The first embodiment shows cooperation between the two work-flow systems. In the second embodiment, a plurality of work-flow-server apparatuses each has a method-server apparatus and performs cooperation processing.

In FIG. 6, there are shown work-flow-server apparatuses 41, 42, . . . , 4n, and 4(n+1), and method-server apparatuses 51, 52, . . . , and 5n. A plurality of work-flow-server apparatuses 41, 42, . . . are connected with each other through the method-server apparatuses 51, 52, . . . via a communication network 50. A mail-server apparatus 60 is connected to the communication network 50. Each method-server apparatus takes out or reads out electronic mail from the mail-server apparatus 60, and when the electronic mail includes a command for the connected work-flow-server apparatus, the method-server apparatus sends an execution command to the work-flow system according to the contents of the electronic mail.

The work-flow-server apparatuses 4n and 4(n+1) share the method-server apparatus 5n. The method-server apparatus 5n takes out electronic mail from the mail-server apparatus 60, and when the electronic mail includes commands for the connected work-flow-server apparatuses 4n and 4(n+1), the method-server apparatus 5n sends execution commands to the corresponding work-flow-server apparatuses 4n and 4(n+1) according to the contents of the electronic mail. When a method-server apparatus itself has sufficient processing capacity, it can be connected to a plurality of work-flow-server apparatuses in this way.

Each work-flow-server apparatus can send electronic mail directly to the mail-server apparatus 60 via the communication network 50 without using a method-server apparatus. Or, mail transmission may be performed by a method-server apparatus instead of being directly performed by a work-flow-server apparatus.

Also in the second embodiment, each work-flow-server apparatus checks whether mail processing has been designated, when processing in each node is finished, in the same way as in the first embodiment. In other words, whether mail processing has been designated is checked when processing in each node is finished, based on flag information for each node, stored in an appropriate area in a memory apparatus.

With this structure, even when many various work flows are independently formed separately in a company, for example, mail processing is designated depending on node processing in each work-flow system and specified mail is sent, so that any work flow in any other work-flow system can be activated. Therefore, cooperation can be easily achieved among a plurality of work-flow systems.

As described above, according to the above two embodiments, cooperation can easily be achieved among work-flow systems.

The above-described command is an activation command for activating a work flow. The command may be a termination command or another command. A termination command can be used to prevent execution of an unnecessary work flow in accordance with a particular condition.

In the above embodiments, whether mail processing has been designated is determined when processing in each node is finished. It may be determined not only when the processing is finished but when the processing is started. In this case, whether processing in the previous node has been finished is determined when processing in the current node is started, and then, mail processing is performed.

The whole or a part of the program executing the above-described processing is recorded or stored in a portable medium, such as a floppy disk or a CD-ROM, or a storage unit such as a hard disk. The program is read by a computer and the whole or a part of operations is executed. Alternatively, the whole or a part of the program can be distributed or provided via a communication network. The user can download the program via the communication network and install it into a computer, or install the program from a recording medium to a computer to easily implement a work-flow-system cooperation method according to the present invention.

Appropriate embodiments of the present invention have been described. Within the gist and the scope of the present invention, various improvements and modifications can be performed now and in the future. Therefore, similar embodiments performed by one skilled in the art are within the scope of the present invention.

As described above, according to the present invention, since one work-flow system can activate a work flow in another work-flow system, cooperation can easily be obtained achieved among a plurality of work-flow systems.

What is claimed is:

1. A work-flow cooperation processing apparatus that achieves cooperation among at least two work-flow systems, a first one of the work-flow systems including at least a first computer apparatus serving as a work-flow server and an electronic mail sender, a second one of the work-flow systems including at least a second computer apparatus serving as a work-flow server, an electronic mail storage, and a network that connects at least the first computer apparatus and the electronic mail storage, the work-flow cooperation processing apparatus comprising:
a method-server apparatus that connects to the network and to the second computer apparatus, that reads electronic mail from the electronic mail storage, the electronic mail being sent from the first computer apparatus and including a command related to work flow in the second work-flow system, and that transmits a command forming part of the electronic mail to the second computer apparatus for execution of the command by the second computer apparatus.

2. A work-flow cooperation processing apparatus according to claim 1, wherein the first computer apparatus sends the electronic mail for storage in the electronic mail storage according to whether electronic-mail processing is designated at each node of a work flow in the first one of the work-flow systems.

3. A work-flow cooperation processing apparatus according to claim 1, wherein the method-server apparatus first determines that the electronic mail read from the electronic mail storage is related to a work flow in the second one of the work-flow systems before transmitting the command to the second computer apparatus.

4. A work-flow cooperation processing apparatus according to claim 1, wherein the command is an activation command that activates a work flow in a work-flow system.

5. A work-flow cooperation processing apparatus according to claim 1, wherein the electronic mail is text data, and the text data includes a parameter specifying a work flow in a work-flow system.

6. A work-flow cooperation processing system, comprising:
first and second work-flow systems;
electronic-mail storage apparatus that stores electronic mail sent from the first work-flow system;
a method-server apparatus that connects to the second work-flow system, that reads electronic mail from the electronic mail storage apparatus, the electronic mail being sent from the first work-flow system and including a command related to work flow in the second work-flow system, and that transmits a command forming part of the electronic mail to the second work-flow system for execution of the command.

7. A work-flow-system cooperation method for a plurality of work-flow systems, comprising the steps of:
storing electronic mail sent from a first one of the plurality of work-flow systems in an electronic-mail storage;
reading out the electronic mail from the electronic-mail storage;
sending a command related to a work flow in a second one of the plurality of work-flow systems to the second one of the work-flow systems, the command included in the read-out electronic mail; and
executing the sent command for the work flow in the second one of the workflow systems.

8. A work-flow-system cooperation method for a plurality of work-flow systems according to claim 7, further comprising the step of:
designating electronic-mail processing in at least one node of a work flow in the first one of the plurality of work-flow systems.

9. A work-flow-system cooperation method for a plurality of work-flow systems according to claim 7, further comprising the step of:
determining that the electronic mail read from the electronic mail storage is related to a work flow in the second one of the work-flow systems before transmitting the command to the second one of the work-flow systems.

10. A program that is executable by a computer for performing a work-flow-system cooperation method for a plurality of work-flow systems, the program executing the steps of:
storing electronic mail sent from a first one of the plurality of work-flow systems in an electronic-mail storage;
reading out the electronic mail from the electronic-mail storage;
sending a command related to a work flow in a second one of the plurality of work-flow systems to the second one of the work-flow systems, the command included in the read-out electronic mail; and
executing the sent command for the work flow in the second one of the work-flow systems.

11. A recording medium for storing a program that is executable by a computer for performing a work-flow-system cooperation method for a plurality of work-flow systems, the program executing the steps of:
storing electronic mail sent from a first one of the plurality of work-flow systems in an electronic-mail storage;
reading out the electronic mail from the electronic-mail storage;
sending a command related to a work flow in a second one of the plurality of work-flow systems to the second one of the work-flow systems, the command included in the read-out electronic mail; and
executing the sent command for the work flow in the second one of the work-flow systems.
